(19) United States
(12) Patent Application Publication
(10) Pub. No.: US 2009/0317049 A1
(43) Pub. Date: Dec. 24, 2009

(54) RECORDING/REPRODUCING SYSTEM, RECORDING DEVICE, AND REPRODUCTION DEVICE

(76) Inventors: Katsumi Adachi, Nara (JP); Nobue Funabiki, Osaka (JP)

Correspondence Address: SNELL & WILMER L.L.P. (Panasonic), 600 ANTON BOULEVARD, SUITE 1400, COSTA MESA, CA, 92626, US

(21) Appl. No.: 12/305,345

(22) PCT Filed: Jul. 12, 2007
(86) PCT No.: PCT/JP2007/063917

§ 371 Date: Dec. 17, 2008

(30) Foreign Application Priority Data
Jul. 12, 2006 (JP) 2006-191393

(51) Int. Cl. H04N 5/93

(52) U.S. Cl. 386/52

(57) ABSTRACT

To provide a recording/playback system capable of improving the accuracy of image adjustment for playing back a video content recorded in a recording medium. A recording/playback system relating to the present invention includes a recording unit and a playback unit. The recording unit determines, as adjustment parameters, control values for controlling values to be output in response to input of recorded pieces of video data included in a video stream each having a predetermined period and having a luminance level that has not yet been adjusted. The recording unit records the determined adjustment parameters and pieces of time information in correspondence with each other. The pieces of time information indicate timings for applying the adjustment parameters to the pieces of original video data. The playback unit outputs the values for playing back the pieces of original video data based on the adjustment parameters recorded in the recording unit.

### TECHNICAL FIELD

The present invention relates to an art for playing back video data, and particularly relates to an art for adjusting image quality of recorded video data and playing back the video data with the adjusted image quality.

### BACKGROUND ART

In recent years, there have been widely used recording/playback devices that record received video contents such as TV broadcasting programs and play back the recorded video contents.

Also, according to conventional recording/playback devices, when video contents are played back, various types of image adjustments are performed so as to save electric power and to improve image quality. For example, luminance adjustment, pixel interpolation for converting interlaced signals into progressive signals (hereinafter, “I/P conversion”), and removal of block noises are performed.

As an art for adjusting a luminance for example, there is disclosed an art for automatically adjusting a luminance level of a video content in accordance with an Average Picture Level (APL) of video signals of the video content being played back, and displaying the video content on a display at the adjusted luminance level. This art aims to save users trouble of adjusting image quality and save electric power (See Patent Document 1).

[Patent Document 1] Japanese Laid-Open Patent Application Publication No. H7-15685

### DISCLOSURE OF THE INVENTION

### Problems the Invention is Going to Solve

However, according to the art disclosed in the Patent Document 1, even when a video content to be played back is a video content that has been recorded before, it is possible to perform image adjustment only while the video content is being played back. This is because image adjustment is performed by extracting luminance signals of video signals from the video content being played back, and calculating an APL based on the extracted luminance signals.

Also, other conventional arts for performing image adjustment are based on an assumption that image adjustment is performed while a video content is being played back, like the above art of the Patent Document 1. Accordingly, it is possible to perform image adjustment only based on video signals of a video content being played back, and there are limitations to these conventional arts for performing image adjustment.

The present invention is made in view of the above problem, and aims to provide a recording/playback system capable of improving the accuracy of image adjustment for playing back a video content recorded in a recording medium compared with conventional systems.

### Means to Solve the Problems

In order to solve the above problem, the present invention provides a recording/playback system that includes a recording device that records therein pieces of video data and a playback device that plays back the recorded pieces of video data, the recording device comprising a recording unit operable to sequentially determine video adjustment parameters for the pieces of video data each having a predetermined period, and record the determined video adjustment parameters and pieces of time information in a recording medium, the pieces of time information indicating display timings of the pieces of video data, and the playback device comprising a playback unit operable to adjust the pieces of video data based on the video adjustment parameters, and display the adjusted pieces of video data in accordance with the display timings indicated by the pieces of time information.

Note that the video adjustment parameters are control values for controlling output of the pieces of video data so as to save electric power and to improve image quality during playback of the pieces of video data. Also, adjustment based on such video adjustment parameters means that values to be output in response to input of recorded pieces of video data are determined in accordance with control values shown by video adjustment parameters to be applied to the pieces of video data.

### EFFECT OF THE INVENTION

With the above structure, throughout the whole of pieces of video data recorded in the recording device, the recording unit can determine video adjustment parameters appropriate for achieving aims such as improvement in image quality and saving of electric power. Accordingly, compared with conventional arts in which video adjustment is performed only based on a video being played back, it is possible to extract elements for performing adjustment from a wider range, and determine video adjustment parameters more accurately and certainly. Also, the recording unit records the determined video adjustment parameters and pieces of time information indicating timings for applying the video adjustment parameters to perform playback, in one-to-one correspondence. Accordingly, each time the playback unit plays back the pieces of video data, the playback unit can control output of the pieces of video data using the video adjustment parameters to be applied to the pieces of video data in accordance with timings indicated by the pieces of time information corresponding to the video adjustment parameters. This reduces processing load for video adjustment during playback.

Also, the video adjustment parameters may be parameters for adjusting luminances of the pieces of video data, and the recording unit may (i) calculate average luminances of the pieces of video data, (ii) judge whether transition of the calculated average luminances matches a predetermined luminance increase pattern, (iii) when judging affirmatively, determine video adjustment parameters for gradually decreasing luminance levels of particular pieces among the pieces of video data, the particular pieces being subsequent to one piece among the pieces of video data whose average luminance is a maximum among the average luminances, and (iv) record the video adjustment parameters determined for the particular pieces and display timings of the particular pieces in the recording medium.

Here, the predetermined luminance increase pattern is a pattern in which a dark scene continues, which has an average luminance no more than a predetermined value, and then a light scene immediately continues, which has an average luminance higher than the average luminance of the dark scene by a constant value, and then a dark scene immediately continues.

As a display device such as a plasma display panel (PDP) has a higher luminance, such a display device generates higher heat and consume more electrical power. Also, in a case where a video switches from a dark scene to a light scene, a user has less uncomfortable feeling even if a luminance level is gradually decreased until the user's eyes start becoming light-adapted. With the above structure, it is possible to detect a piece among recorded pieces of video data that matches the above luminance increase pattern before the pieces of video data are played back. Accordingly, it is possible to determine adjustment parameters for decreasing luminance levels of particular pieces of video data whose display timings are subsequent to a predetermined period since the average luminance has increased to the maximum level. As a result, for the predetermined period since the average luminance has increased to the maximum level, it is possible to give a user an impact of a video caused by switching from a dark scene to a light scene without making the user feel uncomfortable. Also, after the predetermined period has elapsed, it is possible to prevent the display device from generating heat, and save electric power by decreasing the luminance level.

Also, the recording unit may acquire one or more playback conditions for playing back the pieces of video data, and determine the video adjustment parameters in accordance with the acquired one or more playback conditions based on the average luminances of the pieces of video data, and record the determined video adjustment parameters and the pieces of time information in the recording medium.

With the above structure, the recording unit records video adjustment parameters corresponding to playback conditions for playing back pieces of video data and pieces of time information of the pieces of video data in one-to-one correspondence. Accordingly, it is possible to beforehand determine an appropriate luminance in accordance with a playback condition such as a display type and a user's age, and display the pieces of video data with a preferable luminance.

Also, each of the playback conditions may indicate a different one of types of playback devices for playing back the pieces of video data, and the recording device may determine the video adjustment parameters in accordance with the types, and record the determined video adjustment parameters and the pieces of time information respectively corresponding thereto in the recording medium in one-to-one correspondence with the types.

With the above structure, if a plurality of types of display devices are available for playing back the same pieces of video data, it is possible to determine a video adjustment parameter for performing luminance adjustment for each type of the display devices in accordance with a characteristic of the type of the display devices. Accordingly, a plurality of users can each use a different one of the display devices so as to display the same pieces of video, data with a preferable luminance corresponding to the display device.

Also, video signals relating to the pieces of video data may be signals transmitted in an interlaced mode, the recording device may further comprise a judgment unit operable to judge, with respect to each of fields relating to the video signals that is a target field of judgment, whether the target field constitutes a moving image or a still image based on pixels included in at least two fields that correspond in position to a pixel included in the target field, the at least two fields including a field previous to the target field and a field subsequent to the target field, the recording unit may record, as a video adjustment parameter for the field, a result of the judgment made by the judgment unit and a piece of field time information indicating a time that corresponds to the target field in the recording medium in correspondence with each other, and the playback unit converts the video signals into progressive signals by switching between reference fields for interpolating the pixel depending on the result of the judgment included in the video adjustment.

According to a conventional art in which I/P conversion is performed while pieces of video data are being played back by judging whether an I/P conversion target field constitutes a moving image or a still image, it is possible to perform the judgment only based on a pixel included in the I/P conversion target field and a pixel included in a field previous to the I/P conversion target field. If I/P conversion is performed in this way, there is a possibility for example that even if a field previous to an I/P conversion target field and a field subsequent to the I/P conversion target field respectively constitute moving images, the I/P conversion target field might be erroneously judged to constitute a still image. As a result, a blurring image that gives a user uncomfortable feeling will be displayed. With the above structure, the judgment unit can judge whether pixels included in at least two fields including a field previous to an I/P conversion target field and a field subsequent to the I/P conversion target field that correspond in position to a pixel included in the I/P conversion target field have the same value. Accordingly, it is possible to appropriately judge whether the interpolation target field constitutes a moving image or a still image, and therefore display video with little blurring.

Also, the recording unit may embed, as digital watermark, the video adjustment parameter and the piece of time information into the piece of video data, and record, in the recording medium, the piece of video data into which the video adjustment parameter and the piece of time information have been embedded.

With the above structure, video adjustment parameters and pieces of time information are recorded with use of the digital watermark technique together with pieces of video data in one-to-one correspondence. Accordingly, it is possible to record the video adjustment parameters and the pieces of time information without affecting image quality and audio quality of the pieces of video data.

### BRIEF DESCRIPTION OF THE DRAWINGS

FIG. 1 shows a functional structure of a recording/playback system according to a first embodiment;

FIG. 2 shows APL transition and luminance adjustment of video data according to the first embodiment;

FIG. 3 shows a characteristic of luminance adjustment of a display according to the first embodiment;

FIG. 4A shows a gamma characteristic of luminance adjustment according to the first embodiment, and FIG. 4B shows a gamma characteristic of luminance adjustment according to a modification of the first embodiment;

FIG. 5A shows an example of a structure and data of an adjustment APL table used in the first embodiment, FIG. 5B shows an example of a structure and data of an adjustment LUT group used in the first embodiment, and FIG. 5C shows a waveform of a predetermined pattern of luminance variation according to the first embodiment;

FIG. 6 shows a flow of adjustment parameter recording processing according to the first embodiment;

FIG. 7 shows a flow of parameter setup recording processing according to the first embodiment;

FIG. 8 shows a flow of playback processing according to the first embodiment;

FIG. 9 shows a method of judging whether an I/P conversion target field constitutes a moving image or a still image;

FIG. 10 shows a functional structure of a recording/playback system according to a second embodiment;

FIG. 11 shows a flow of moving/still image judgment processing according to the second embodiment;

FIG. 12 shows a flow of playback processing according to the second embodiment;

FIG. 13 shows a functional structure of a recording/playback system according to a third embodiment;

FIG. 14A shows a frequency spectrum with no block noise after FFT processing has been performed, and FIG. 14B shows a frequency spectrum with block noise after FFT processing has been performed;

FIG. 15 shows a flow of adjustment parameter recording processing according to the third embodiment;

FIG. 16 shows a flow of block noise detection processing according to the third embodiment;

FIG. 17 shows a flow of playback processing according to the third embodiment; and

FIG. 18 is graphs showing a relation between variation of papillary diameter of a user who watches a screen switching from a dark scene to a light scene and switching from the light screen to a dark scene and screen luminance.

### DESCRIPTION OF CHARACTERS

100, 200, and 300: recording/playback system
110, 210, and 310: recording unit
111: video storage unit
112, 212, and 312: parameter extraction unit
113: parameter setup unit
114, 216, and 316: parameter storage unit
120, 220, and 320: playback unit
121, 221, and 321: adjustment unit
122: LUT
123: LUT setup unit
124: display unit
213 and 222: n−1 field memory
214: n+1 field memory
215: n field moving/still image judgment unit
223 and 313: n field memory
224 and 322: I/P conversion unit
314: FFT processing unit
315: block noise detection unit
317: moving/still image judgment information storage unit
318: block noise information storage unit
323: LPF
324: LPF control unit

### BEST MODE FOR CARRYING OUT THE INVENTION

### First Embodiment

### Outline

A recording/playback system relating to the present invention includes a recording unit and a playback unit. The recording unit determines, as adjustment parameters, control values for controlling values to be output in response to input of recorded pieces of video data included in a video, stream each having a predetermined period and having a luminance level that has not yet been adjusted. Hereinafter, such pieces of video data whose luminance levels have not yet been adjusted are referred to as “pieces of original video data”. The recording unit records the determined adjustment parameters and pieces of time information in correspondence with each other. The pieces of time information indicate timings for applying the adjustment parameters to the pieces of original video data. The playback unit outputs the values for playing back the pieces of original video data based on the adjustment parameters recorded in the recording unit.

According to the recording/playback system relating to a first embodiment of the present invention, in order to play back a video stream recorded in the recording unit on a PDP in accordance with a user's playback operation, the recording unit beforehand determines adjustment parameters for adjusting luminance levels of pieces of video data of the video stream before playback of the video stream is started, and records the determined adjustment parameters and pieces of time information indicating timings for applying the adjustment parameters to the pieces of video data. Also, the playback unit adjusts the luminance levels based on control values shown by the adjustment parameters to display the pieces of video data on the PDP in accordance with the timings indicated by the pieces of time information recorded in the recording unit.

The following describes normal luminance adjustment for playing back a video stream on a PDP.

The playback unit according to the first embodiment calculates an APL in units of frames based on video signals of an input video stream, and refers to a Look-Up Table (LUT) group that includes LUTs each having stored therein a control value determined in advance for adjusting a luminance level, and determines a luminance level for each pixel of each frame based on a control value included in an LUT corresponding to the calculated APL so as to display the video stream.

In a case where a video stream is displayed on a PDP, as shown by a broken line 31 in FIG. 3, the playback unit adjusts a luminance level using an LUT including a control value that is determined such that a white peak luminance increases as an APL of apiece of original video data decreases, and also, adjusts the luminance level using an LUT including a control value that is determined such that the white peak luminance decreases as the APL increases.

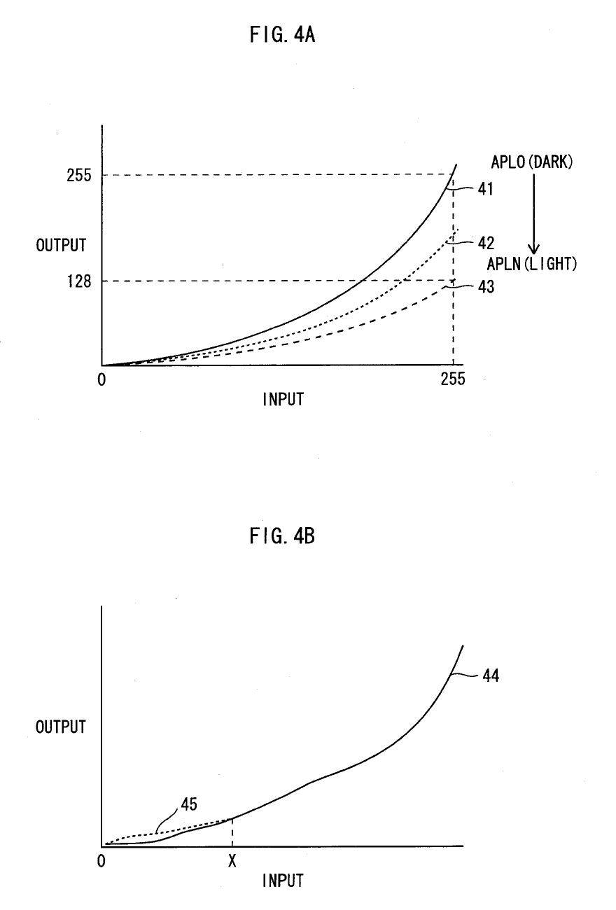

The LUT group according to the first embodiment includes LUTs each storing therein a control value that is determined such that a luminance level represented by any one of gamma characteristic curves 41-43 at APLs 0-N shown in FIG. 4A (hereinafter, “adjustment APL”) is output in response to an APL of an input video signal. A value represented by the gamma characteristic curve 41 at APL 0 is output in a case where an APL of a piece of original video data is an APLmin, which is a predetermined level. A value represented by the gamma characteristic curve 43 at APL N is output, in a case where an APL of a piece of original video data is an APLmax, which is a predetermined level.

The following describes luminance control that is a characteristic of the first embodiment.

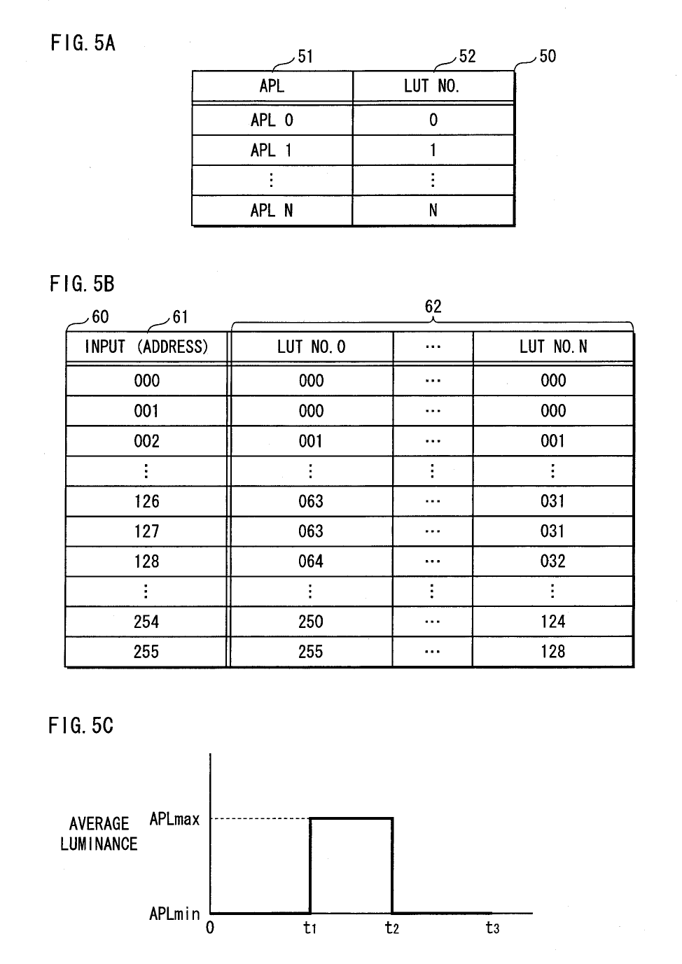

The recording unit according to the first embodiment records a video stream received from a broadcasting station or the like in a recording medium, and calculates an APL based on luminance signals of the recorded video stream in units of frames, and detects whether APL transition includes a part that matches a luminance transition pattern as shown in FIG. 5C (hereinafter, “predetermined pattern”) by no less than a predetermined degree.

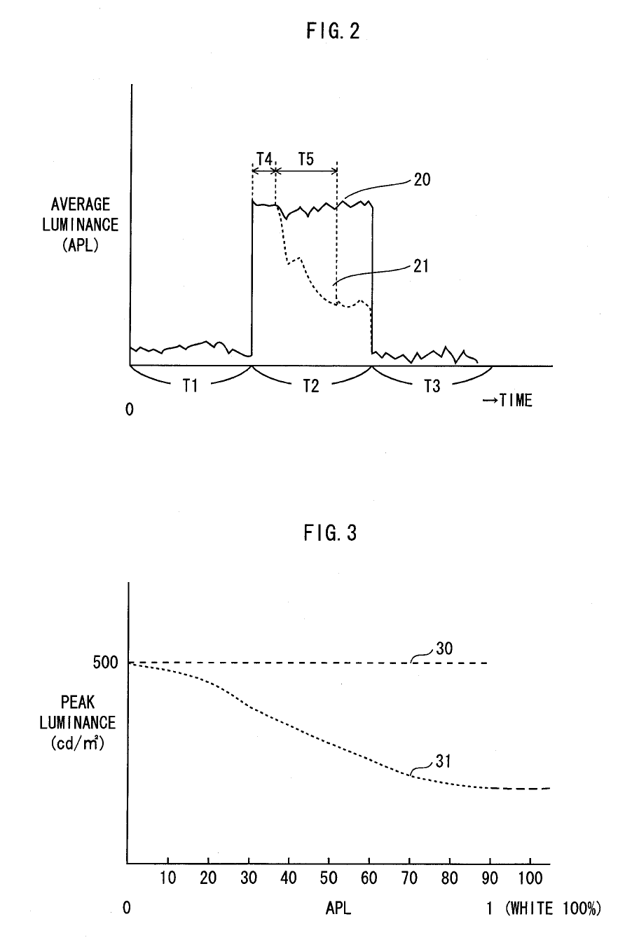

As shown in FIG. 2, if detecting that the APL transition includes a part that matches the predetermined pattern by no less than the predetermined degree, the recording unit determines an APL for playing back a piece of video data corresponding to a period T2 whose luminance has rapidly increased, such that a white peak luminance gradually decreases as represented by a broken line 21 in FIG. 2. Then, the recording unit records, as a piece of time information, a field number of a frame to which the determined APL is to be applied, and also records, as an adjustment parameter, an LUT number for identifying an LUT corresponding to the determined APL in correspondence with the piece of time information.

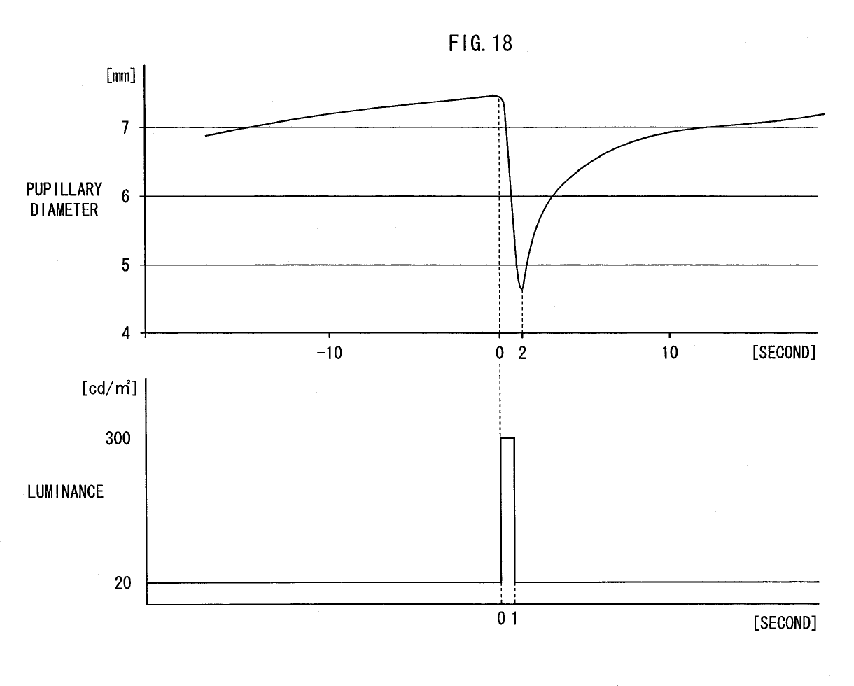

Here, the following refers to desirable specific values as a period for keeping an increased luminance and a period for gradually decreasing the increased luminance that are included in the period T2 shown in FIG. 2. FIG. 18 is graphs showing a relation between papillary reaction actually measured by the present inventors and screen luminance. In FIG. 18, the upper graph shows variation in pupillary diameter, and the lower graph shows variation in luminance. The upper graph here shows variation in pupillary diameter from a state where eyes have been watching a dark scene at approximately 20 cd/m² to a state where eyes watch a light scene at 300 cd/m² for one second. As can be seen from the upper graph in FIG. 18, the pupils start constricting and the pupillary diameter starts decreasing from the moment when the eyes watch a light scene, and continue to constrict even after the screen switches from the light scene to a dark scene. Then, the pupils end constricting approximately two seconds after the eyes have watched the light screen, and then the pupils again start dilating. This proves that it is necessary to keep the initial luminance of the light screen for no less than two seconds in order to maintain an impact of a video caused by screen switching from the dark scene to the light scene. In other words, a period T4, which is represented by a crossover of a solid line 20 and a broken line 21 in FIG. 2, needs to be no less than two seconds. Note that the variation in pupillary diameter shown in FIG. 18 is the average value of a great number of sample values.

When a user goes out of a dark place to a light place, the user's eyes adapt to the light place. This phenomenon is referred to as “light adaptation”. Generally, light adaptation needs approximately one minute to complete. Accordingly, suppose that a period for gradually decreasing the luminance is set to no more than approximately 30 seconds, which is shorter than the above approximately one minute necessary for light adaptation. In this case, even if the luminance is decreased, a user watching a screen has difficulty recognizing that the screen becomes dark. Therefore, a period T5 shown in FIG. 2 for gradually decreasing the luminance is desirably no more than 30 seconds.

In order to play back a piece of video data having a field number recorded by the above recording unit, the playback unit according to the first embodiment determines a luminance level of the piece of video data with use of an LUT having an LUT number that is recorded in correspondence with the field number, and displays the piece of video data at the determined luminance level.

Note that expansion processing for playing back video data compressed in accordance with the MPEG-2 standard or the like is not a characteristic part of the present Application, and accordingly the descriptions thereof are omitted in the Specification.

### <Structures>

The following describes the structure of the recording/playback system according to the first embodiment described above.

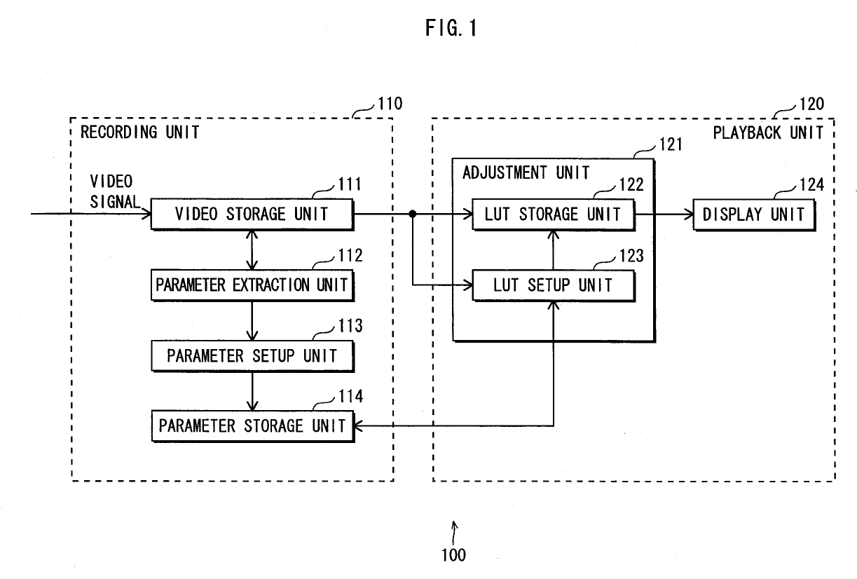

FIG. 1 shows a functional structure of a recording/playback system 100 according to the first embodiment.

The recording/playback system 100 includes a recording unit 110 and a playback unit 120, as described above. The recording unit 110 records therein an LUT number that is an identifier of an LUT for adjusting a luminance level for playing back a piece of video data that matches the predetermined pattern and a field number of a frame to which the LUT having the LUT number is to be applied. The playback unit 120 plays back a video stream including pieces of video data recorded in a recording medium.

The following describes the compositional elements included in the recording/playback system 100.

### <Recording Unit 110>

The recording unit 110 includes a video storage unit 111, a parameter extraction unit 112, a parameter setup unit 113, and a parameter storage unit 114.

Here, the video storage unit 111 is a recording medium such as a hard disk drive, and stores video data of an MPEG-2 video stream for example which is received from a broadcasting station or the like.

The parameter extraction unit 112 reads a video stream stored in the video storage unit Ill in units of frames, extracts a luminance signals for each frame, and transmits the luminance signals extracted for each frame and a field number of a field included in the frame to the parameter setup unit 113.

The parameter setup unit 113 calculates APLs based on the luminance signals extracted for each frame, and detects whether transition of the calculated APLs includes a part that matches the predetermined pattern by no less than the predetermined degree.

Here, the predetermined pattern is described.

FIG. 5C shows a waveform of the predetermined pattern. This waveform is used by the parameter setup unit 113 to detect whether APL transition of original video data includes a part that matches the predetermined pattern by no less than the predetermined degree, in other words, whether the APL transition includes a part that has a partial correlation with the predetermined pattern by no less than a predetermined level.

In FIG. 5C, an APLmin is a minimum value in the predetermined pattern, and is an APL used in a case where a value is output at APL “0” shown in FIG. 4A. An APLmax is a maximum value in the predetermined pattern, and is an APL used in a case where a value is output at an APL “N” shown in FIG. 4A. The APLmin and the APLmax differ from each other by no less than a predetermined value. Also, an interval between a time t1 and a time t2 in the waveform shown in FIG. 5C is approximately 10 seconds.

The judgment on whether APL transition includes a part that matches the predetermined pattern by no less than the predetermined degree is performed in the following way, for example: it is detected whether APL transition includes a part that has partial correlation with the waveform by no less than the predetermined level, by shifting the predetermined pattern represented by the waveform shown in FIG. 5C at predetermined time intervals.

Also, the parameter setup unit 113 stores beforehand therein, in one-to-one correspondence, a plurality of adjustment APLs for adjusting a luminance to play back a video stream and LUT numbers for each identifying an LUT corresponding to a different one of the plurality of adjustment APLs.

Furthermore, if APL transition of a video stream includes a part that matches the predetermined pattern by no less than the predetermined degree, the parameter setup unit 113 specifies a field whose APL has increased from the APLmin to the APLmax (hereinafter, “APL increased field”), and determines an LUT based on an APL of an original video stream and an adjustment APL such that a luminance level of a field subsequent to the APL increased field decreases at predetermined time intervals t. Then, the parameter setup unit 113 transmits, to the parameter storage unit 114, an LUT number of the determined LUT and a field number of a frame to which the LUT is to be applied.

The parameter storage unit 114 is a recording medium such as a hard disk and a memory, and stores therein parameters to be applied to playback (hereinafter, “playback applicable parameter”) that each show an LUT number of an LUT that is determined for each piece of video data and a field number to which the LUT is to be applied in correspondence with each other.

### <Playback Unit 120>

The playback unit 120 includes an adjustment unit 121 and a display unit 124. These compositional elements are described in detail below.

The adjustment unit 121 includes an LUT 122 and an LUT setup unit 123. In accordance with a user's playback instruction, the adjustment unit 121 reads pieces of video data included in a video stream stored in the video storage unit 111 in units of frames, and determines a luminance level for each of the pieces of video data based on a control value of an LUT stored in the LUT 122. Then, the adjustment unit 121 transmits the piece of video data and the determined luminance level to the display unit 124 such that the piece of video data is displayed at the determined luminance level.

The LUT 122 is a memory such as a RAM (Random Access Memory), and stores therein LUTs to be applied to display of video data read for each frame having a field number. Note that each of the LUTs is a table that shows the correspondence between luminance of a piece of video data and a control value for controlling a luminance level for playing back the piece of video data.

The LUT setup unit 123 stores therein control values included in LUTs respectively corresponding to LUT numbers, and sequentially reads playback applicable parameters respectively corresponding to read pieces of video data. Also, the LUT setup unit 123 calculates an APL of each of the pieces of video data, and stores a control value of an LUT having an LUT number corresponding to the calculated APL in the LUT 122. Furthermore, if a field number of a frame of the piece of video data matches a field number shown by a playback applicable parameter corresponding to the frame, the LUT setup unit 123 stores a control value of an LUT having an LUT number shown by the playback applicable parameter in the LUT 122. Note that the LUT setup unit 123 stores a control value in the LUT 122 during the vertical blanking interval.

The display unit 124 is a display such as a PDP and a liquid crystal display (LCD), and displays each frame of read pieces of video data at a luminance level determined by the adjustment unit 121.

### <Data>

The following describes table data stored in the recording/playback system 100 according to the first embodiment.

FIG. 5A shows an example of the structure and data of an adjustment APL table stored in advance in the parameter setup unit 113.

In FIG. 5A, an adjustment APL table 50 stores therein an APL group 51 including APLs and an LUT number group 52 including LUT numbers in one-to-one correspondence.

The APLs included in the APL group 51 are sectioned every predetermined value. Control is performed in advance so as to output any one of values respectively represented by the gamma characteristic curves 41-43 shown in FIG. 4A in accordance with each APL.

Each of the LUT numbers included in the LUT number group 52 is an identification number for identifying an LUT, which stores therein a control value that is determined so as to output any one of the values respectively represented by the gamma characteristic curves 41-43.

FIG. 5B shows an example of the structure and data of adjustment LUTs stored in advance in the LUT setup unit 123.

As shown in FIG. 5B, an adjustment LUT group 60 stores therein an input (address) group 61 including addresses and an LUT number group 62 including LUT numbers O-N in one-to-one correspondence.

Each of the inputs (addresses) included in the input (address) group 61 shows an address in the LUT 122 into which each luminance signal of original video data is input. Also, each of the LUT numbers O-N included in the LUT number group 62 is an identification number for identifying an LUT, and a table value included in each of the LUTs respectively having the LUT numbers O-N is stored at an address included in the input (address) group 61 corresponding to the LUT number in the LUT 122.

### <Operations>

The following describes operations of the recording/playback system 100 according to the first embodiment.

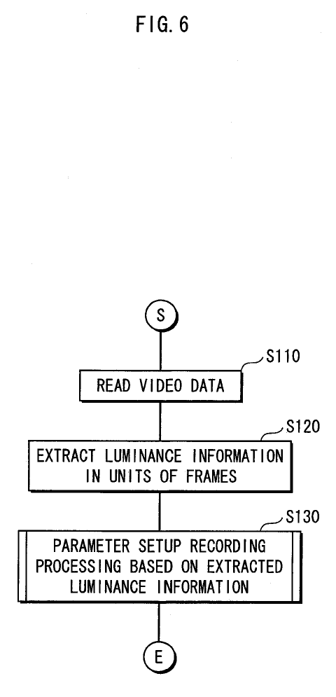

FIG. 6 shows a flow of the adjustment parameter recording processing by the recording/playback system 100 according to the first embodiment.

The adjustment parameter recording processing is described with reference to FIG. 6.

The parameter extraction unit 112 sequentially reads pieces of video data in units of frames from the video storage unit 111 (Step S110), extracts luminance signals for each frame, and transmits the luminance signals extracted for each frame and a field number corresponding to the frame to the parameter setup unit 113 (Step S120).

Then, the parameter setup unit 113 calculates an APL based on the luminance signals extracted for each frame in Step S120, and performs parameter setup recording processing (Step S130).

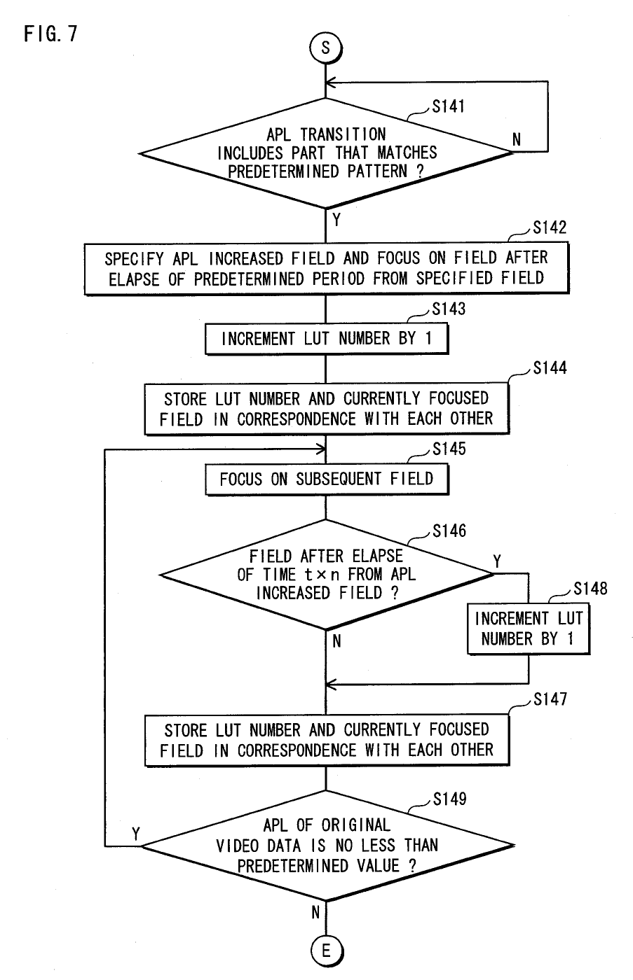

The parameter setup recording processing is described with reference to FIG. 7.

Note that, before performing the parameter setup recording processing, the parameter setup unit 113 sets up an LUT number “0” in a memory as an initial LUT number.

In Step S141 of FIG. 7, the parameter setup unit 113 judges whether transition of the APLs calculated based on the luminance signals extracted for each frame in Step S120 includes a part that matches the waveform of the predetermined pattern shown in FIG. 5C. More specifically, the parameter setup unit 113 calculates a correlation coefficient by shifting the waveform shown in FIG. 5C for each frame in order to judge whether the transition of the APLs has a partial correlation with the waveform.

If judging affirmatively (Step S141: Y), the parameter setup unit 113 specifies, as an APL increased field, a field whose APL has increased from the APLmin to the APLmax as shown in FIG. 5C, and focuses on a field corresponding a time after elapse of a predetermined period from a time corresponding to the APL increased field (Step S142).

The parameter setup unit 113 increments the LUT number stored in the memory by 1 (Step S143), updates the stored LUT number with the incremented LUT number in the memory, and stores the incremented LUT number and a field number of the focused field in the parameter storage unit 114 in correspondence with each other (Step S144).

Then, the parameter setup unit 113 focuses on a field subsequent to the focused field (Step S145), and judges whether the currently focused field is a field corresponding to a time after elapse of a predetermined period t×n (n=1, 2, 3 . . . ) from the time corresponding to the APL increased field specified in Step S142 (Step S146).

If judging negatively (Step S146: N), the parameter setup unit 113 records the LUT number stored in the memory and a field number of the currently focused field in the parameter storage unit 114 in correspondence with (Step 5147).

Also, if judging affirmatively (Step S146: Y), the parameter setup unit 113 increments the LUT number stored in the memory in Step S144 by 1, and updates the stored LUT number with the incremented LUT number in the memory (Step S148), and then performs processing of Step S147.

Then, the parameter setup unit 113 judges whether an APL of original video data is no less than the predetermined value (Step S149).

If judging affirmatively (Step S149: Y), the parameter setup unit 113 repeats Step S145 and subsequent Steps.

Also, if judging negatively (Step S149: N), the parameter setup unit 113 ends the parameter setup recording processing.

The following describes playback processing by the recording/playback system 100 according to the first embodiment.

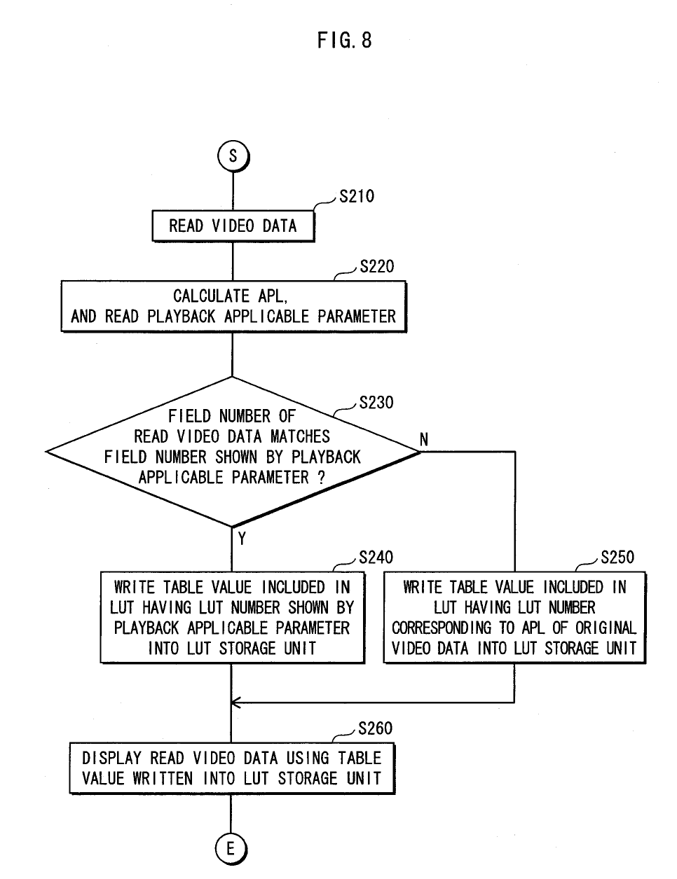

FIG. 8 shows a flow of the playback processing by the recording/playback system 100. The playback processing is described with reference to FIG. 8.

In accordance with a user's playback instruction, the adjustment unit 121 sequentially reads pieces of video data in units of frames from the video storage unit 111, and transmits luminance signals extracted for each frame of the read pieces of data to the LUT setup unit 123, and also transmits the read pieces of video data to the LUT 122 in units of fields (Step S210).

The LUT setup unit 123 calculates an APL based on the luminance signal extracted for each frame, and reads a playback applicable parameter stored in the parameter storage unit 114 (Step S220).

The LUT setup unit 123 judges whether a field number shown by the playback applicable parameter read in Step S220 matches a field number of the frame read in Step S210 (Step S230).

If judging affirmatively (Step S230: Y), the LUT setup unit 123 reads the adjustment LUT group 60, and selects a table value included in an LUT having an LUT number shown by the playback applicable parameter read in Step S220, and then writes the selected table value into the LUT 122 (Step S240).

Also, if judging negatively (Step S230: N), the LUT setup unit 123 writes, into the LUT 122, a table value included in an LUT having an LUT number corresponding to the APL calculated in Step S220 (Step S250).

The display unit 124 outputs the table value written into the LUT 122 corresponding to luminance signals of a piece of video data, and displays the piece of video data (Step S260).

### Modification of First Embodiment

### Outline

Here, suppose, in recorded video data, that a dark scene continues for a predetermined period (period T1 shown in FIG. 2) and rapidly switches to a light scene, and the light scene continues for a predetermined period (period T2 shown in FIG. 2) and then again rapidly switches to a dark scene, and the dark scene continues for a predetermined period (period T3 shown in FIG. 2). In such an above case, it can be predicted according to the above first embodiment that the last dark scene rapidly switches to a light scene after elapse of the period T3, and the light scene continues for a predetermined period.

Therefore, according to the first embodiment, luminance adjustment is performed in the following way: if a video switches from a dark scene to a light scene as shown in the APL transition of FIG. 2, the light scene is displayed at a luminance of original video data for a predetermined period so as to keep an impact of video caused by luminance transition, and then the luminance is gradually decreased at predetermined intervals so as to suppress heat generation by the PDP and save electric power.

In a modification of the first embodiment, in the same way as in the first embodiment, it can be predicted that after a light scene continues for a predetermined period (period T2 shown in FIG. 2), the light scene rapidly switches to a dark scene and the dark scene continues for a predetermined period (period T3 shown in FIG. 2).

Accordingly, in this modification, in consideration that users have difficulty in identifying a dark part of a video at the moment when the video switches from a light scene to a dark scene after a user's eyes start becoming light-adapted, a control value is determined for performing luminance adjustment so as to increase the tone of the dark part of the video by a predetermined value, and the luminance is adjusted so as to enable the user to easily watch the dark part of the video. Also, before the user's eyes start becoming dark-adapted, control is performed so as to output a luminance corresponding to APL of an original video data.

Since a period necessary for dark adaptation is longer than a period necessary for light adaptation, a period for increasing the tone of the dark part of the video by the predetermined value as described above is desirably at least no less than 10 seconds.

The following focuses on differences of parameter setup recording processing between this modification and the first embodiment. Note that playback processing according to this modification is the same as the playback processing according to the first embodiment, and accordingly the descriptions thereof are omitted.

FIG. 4B shows a gamma characteristic to be applied to the period T3 in which video rapidly switches from a light scene to a dark scene in a case where an APL of original video data varies as shown in FIG. 2.

The LUT setup unit 123 stores, in the adjustment LUT group 60, an LUT including a control value for outputting a value represented by a gamma characteristic curve 44, in the same way as in the first embodiment. Also, the parameter setup unit 113 stores an LUT number of the LUT and an APL corresponding to the gamma characteristic curve 44 in the adjustment APL table 50.

Also, in a case where APL transition of original video data includes a part that matches the predetermined pattern shown in FIG. 5C, the LUT setup unit 123 stores, in the adjustment LUT group 60, an LUT including a control value that is determined such that until a predetermined period elapsed since the APLmax has varied to the APLmin as shown by the broken line 45 in FIG. 4B, a value greater than the value represented by the gamma characteristic curve 44 is output in response to an input value no more than a predetermined value x.

In the same way as in the first embodiment, the parameter setup unit 113 calculates APLs based on luminance signals extracted for each frame, and judges whether transition of the calculated APLs includes a part that matches the predetermined pattern.

If judging affirmatively, the parameter setup unit 113 specifies a field whose APL has decreased from the APLmax to the APLmin (hereinafter, “APL decreased field”).

With respect to each of fields respectively corresponding to times after elapse of a predetermined period from a time corresponding to the APL decreased field, the parameter setup unit 113 determines an LUT including a control value for outputting a value represented by the broken line 45 of FIG. 4B based on an APL of an original video stream and a corresponding adjustment APL, and transmits a field number of the field and an LUT number of the determined LUT to the parameter storage unit 114, as a playback applicable parameter.

The parameter storage unit 114 stores therein the field number transmitted by the parameter setup unit 113 and the LUT number in correspondence with each other, in the same way as in the first embodiment.

### Second Embodiment

### Outline

According to a recording/playback system relating to the second embodiment, based on each piece of video data of a video stream recorded in a recording medium, a parameter to be applied to playback of the piece of video data is determined and recorded, and then the piece of video data is played back using the recorded parameter, in the same way as in the first embodiment.

According to the recording/playback system relating to the second embodiment, based on pieces of video data of a video stream recorded by receiving interlaced video signals, a recording unit judges whether a field of a target of an I/P conversion (hereinafter, “I/P conversion target field”) constitutes a moving image or a still image. Then, the recording unit records a result of the judgment as an adjustment parameter. A playback unit interpolates the I/P conversion target field based on the result of the judgment shown by the adjustment parameter so as to generate a frame and play back the generated frame.

Here, methods according to the second embodiment and conventional arts of judging whether an I/P conversion target field including an interpolation target pixel constitutes a moving image or a still image (hereinafter, “moving/still image judgment”) are described separately.

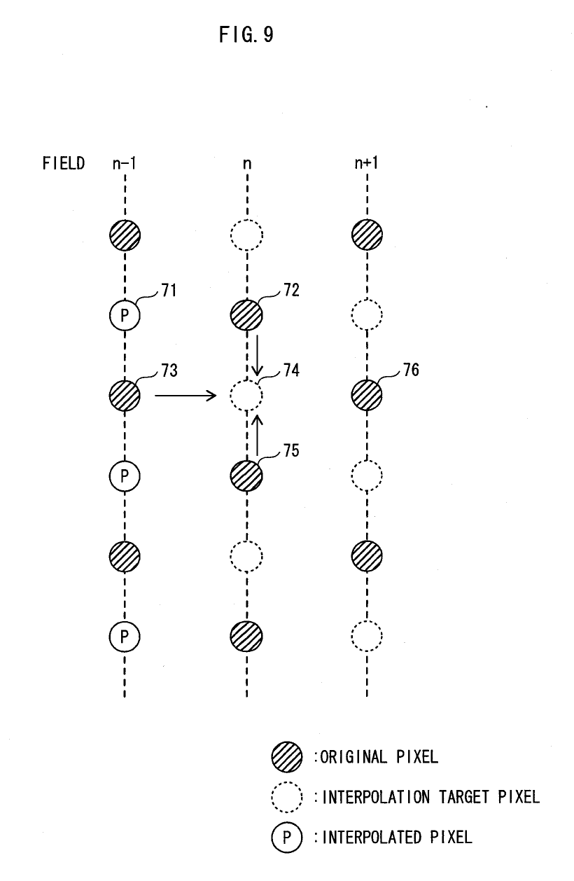

Firstly, the conventional method of making moving/still image judgment is described with reference to FIG. 9.

In FIG. 9, n−1, n, and n+1 fields are successive along the time axis. Pixels included in each of the fields are arranged in the same row so as to correspond in position to each other. FIG. 9 shows that interpolation processing has been already performed on the field n−1, and moving/still image judgment is made on an interpolation target pixel of the n field.

For example, in order to perform interpolation processing on an interpolation target pixel 74, an original pixel 72 arranged in a line above a line in which the interpolation target pixel 74 is arranged is compared with an interpolated pixel 71 arranged in a position corresponding to the interpolation target pixel 74. If the original pixel 72 and the interpolated pixel 71 have the same value, the n field including the interpolation target pixel 74 is judged to constitute a still image. In this case, the interpolation target pixel 74 is interpolated using a value of an original pixel 73 of the n−1 field.

Also, if the original pixel 72 and the interpolated pixel 71 do not have the same value, the n field including the interpolation target pixel 74 is judged to constitute a moving image. In this case, the interpolation target pixel 74 is interpolated using values of the original pixel 72 and the original pixel 75 respectively arranged in lines above and below the interpolation target pixel 74.

Next, the method of making moving/still image judgment according to the second embodiment is described with reference to FIG. 9.

In order to perform interpolation processing on the interpolation target pixel 74 like the above conventional method, the original pixel 73 of the n−1 field and an original pixel 76 of the n+1 field that correspond in position to the interpolation target pixel 74 are compared with each other.

If the original pixel 73 and the original pixel 76 have the same value, the n field including the interpolation target pixel 74 is judged to constitute a still image. Also, if the original pixel 73 and the original pixel 76 do not have the same value, the n field including the interpolation target pixel 74 is judged to constitute a moving image. Note that a subsequent method of interpolating the interpolation target pixel 74 is the same as that in the above conventional method.

According to the above conventional interpolation method, even if, for example, the n−1 field including the original pixel 73 and the n+1 field including the original pixel 76 respectively constitute moving images, there is a possibility that the interpolation target pixel 74 might be interpolated using a value of a pixel of the n−1 field. Especially, if interpolation processing is performed on a monochrome image based on wrong moving/still image judgment, users will have strong uncomfortable feeling.

In the second embodiment, in view of the above problem, moving/still image judgment is not made in real time, unlike the conventional judgment method. Accordingly, moving/still image judgment is made by extracting values of pixels of fields that are previous to and subsequent to a field that is a target of the judgment so as to surely detect a field that constitutes a moving image.

### <Outline>

The following describes the structure of a recording/playback system 200 according to the second embodiment.

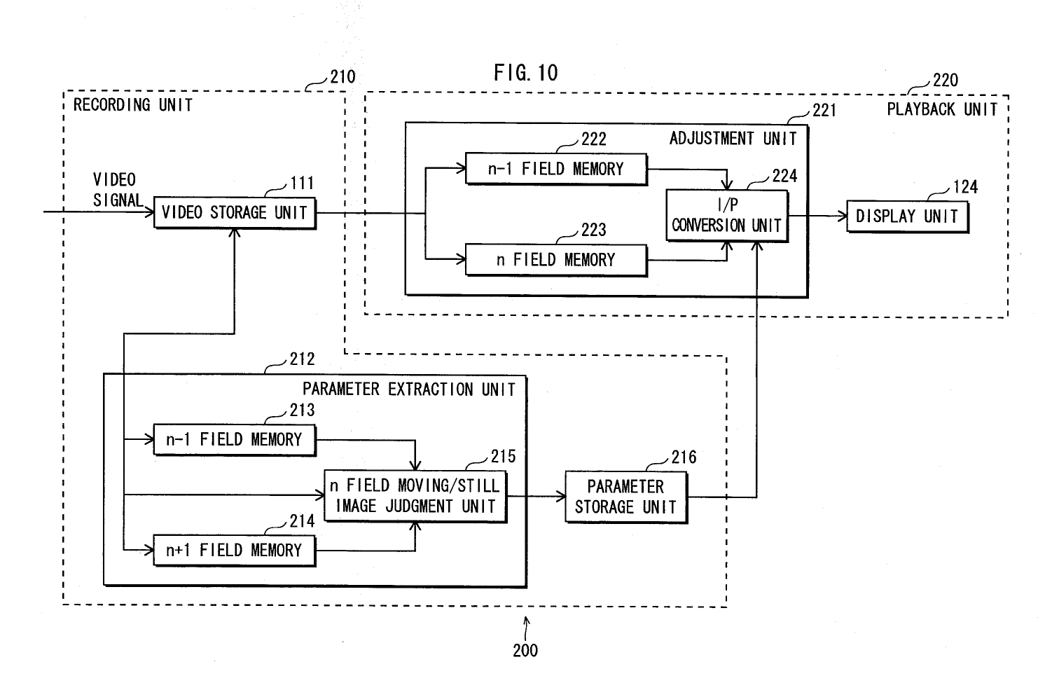

FIG. 10 shows a functional structure of a recording/playback system 200 according to the second embodiment. The compositional elements included in the recording/playback system 200 that are the same as those in the first embodiment are denoted with the same reference numbers.

The recording/playback system 200 includes a recording unit 210 and a playback unit 220. The recording unit 210 records therein a result of moving/still image judgment for each pixel of frames. The playback unit 220 performs I/P conversion on a piece of video data using the results of moving/still image judgment recorded in the recording unit 100 so as to play back the piece of video data.

The following describes the details of the above compositional elements included in the recording/playback system 200. Description of the structures that are the same as those in the first embodiment is omitted.

The recording unit 210 includes a video storage unit 111, a parameter extraction unit 212, and a parameter storage unit 216.

The parameter extraction unit 212 includes an n−1 field memory 213, an n+1 field memory 214, and an n field moving/still image judgment unit 215.

The parameter extraction unit 212 specifies a field that is a target of moving/still image judgment (hereinafter “n field”) among all fields of a recorded video stream, and reads fields previous to and subsequent to the specified n field (hereinafter “n−1 field” and “n+1 field”), and transmits the read fields to the field memories respectively corresponding thereto.

The n−1 field memory 213 and the n+1 field memory 214 are each a memory such as a RAM, and stores therein pieces of video data transmitted by the parameter extraction unit 212.

The n−1 field memory 213 stores therein the read n−1 field of the piece of video data, and the n+1 field memory 214 stores therein the read n+1 field of the piece of video data.

The n field moving/still image judgment unit 215 makes moving/still image judgment on an interpolation target pixel of an n field based on values of pixels of fields of pieces of video data respectively stored in the n−1 field memory 213 and the n+1 field memory 214, and transmits a result of the moving/still image judgment and a field number of a frame on which the judgment has been made to the parameter storage unit 216.

The parameter storage unit 216 stores therein moving/still image judgment information showing the result of the moving/still image judgment transmitted by the parameter extraction unit 212 and the field number in correspondence with each other.

The playback unit 220 includes an adjustment unit 221 and a display unit 124. The adjustment unit 221 includes an n−1 field memory 222, an n field memory 223, and a frame generation unit 224.

In accordance with a user's instruction for playing back video data, the adjustment unit 221 reads a piece of a field that is a target of I/P conversion (hereinafter, “n field”) and a piece of video data of a field previous to the n field (hereinafter, “n−1 field”) from the recording unit 210, and transmits the n field and the n−1 field of the video data to the memory 223 and the n−1 field memory 222, respectively.

The n−1 field memory 222 and the n field memory 223 are each a memory such as a RAM, and stores therein fields of pieces of video data transmitted by the adjustment unit 221.

The I/P conversion unit 224 reads pieces of video data from the n−1 field memory 222 and the n field memory 223. Also, the I/P conversion unit 224 reads moving/still image judgment information corresponding to the n field. Furthermore, the I/P conversion unit 224 performs interpolation processing on an interpolation target pixel of the n field based on the read moving/still image judgment information and the pieces of video data, synthesizes a value of an original pixel and a value of an interpolation target pixel to convert the video data to video data in the progressive format, and transmits a value of the pixel after the conversion has been performed to the display unit 124.

### <Operations>

The following describes operations of the recording/playback system according to the second embodiment described above.

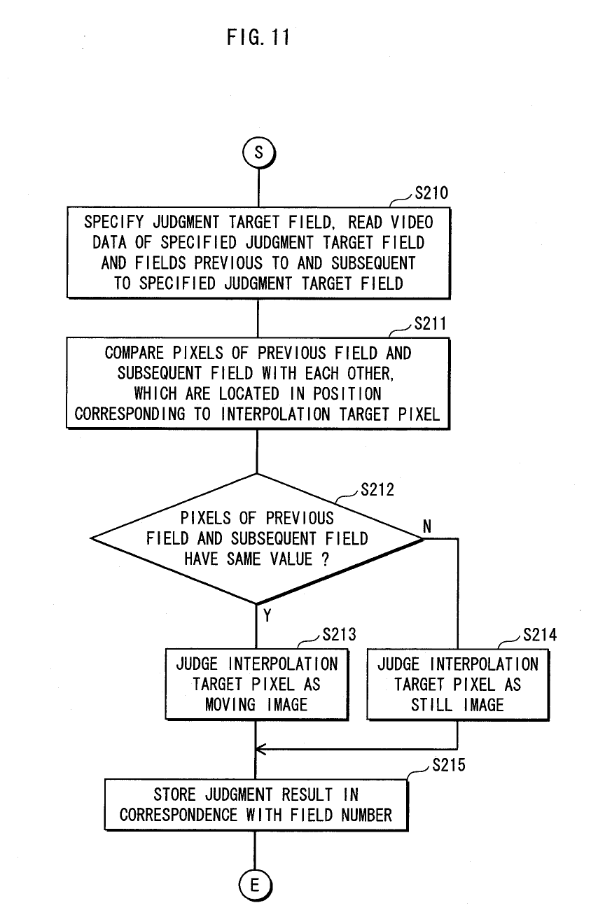

FIG. 11 shows an operation flow of moving/still image judgment processing in the recording/playback system according to the second embodiment.

In Step S210, the parameter extraction unit 212 specifies an n field of a piece of video data among fields of pieces of video data stored in the video storage unit 111, and reads pieces of video data of an n−1 field and an n+1 field from the video storage unit 111, and transmits the piece of video data of the n−1 field to the n−1 field memory 213, and transmits the n+1 field to the n+1 field memory 214.

The n field moving/still image judgment unit 215 reads the pieces of video data from the n−1 field memory 213 and the n+1 field memory 214. Then, with respect to each of interpolation target pixels of the n field, the n field moving/still image judgment unit 215 compares pixels of the n−1 field and the n+1 field with each other that correspond in position to the interpolation target pixel (Step S211).

Next, the n field moving/still image judgment unit 215 judges whether the pixels compared in Step S211 have the same value (Step S212).

If judging affirmatively (Step S212: Y), the n field moving/still image judgment unit 215 judges that the n field including the interpolation target pixel constitutes a moving image, and transmits a result of the judgment and a field number of the n field to the parameter storage unit 216 (Step S213).

Also, if judging negatively (Step S212: N), the n field moving/still image judgment unit 215 judges that the n field including the interpolation target pixel constitutes a still image, and transmits a result of the judgment and a field number of the n field to the parameter storage unit (Step S214).

The parameter storage unit 216 stores therein the judgment result and the field number transmitted in Step S213 or Step S214 in correspondence with each other (Step S215).

The following describes playback processing in the recording/playback system according to the second embodiment.

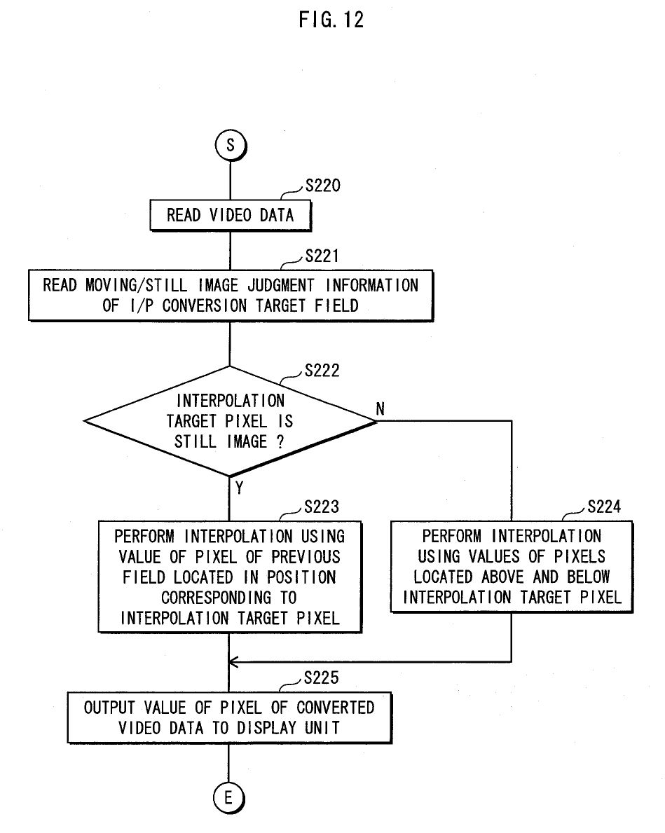

FIG. 12 shows a flow of playback processing in the recording/playback system 200 according to the second embodiment. The playback processing is described with reference to FIG. 12.

In Step S220, the adjustment unit 221 specifies an n field that is an I/P conversion target from the video storage unit 111 in accordance with a user's playback instruction, and reads pieces of video data of an n−1 field and an n field from the video storage unit 111, and transmits the piece of video data of the n−1 field to the n−1 field memory 213, and transmits the piece of video data of the n field to the n field memory 214.

The I/P conversion unit 224 reads values of pixels of fields from the n−1 field memory 222 and the n field memory 223, and reads moving/still image judgment information of the n field from the parameter storage unit 216 (Step S221).

Then, the I/P conversion unit 224 refers to a result of moving/still image judgment with respect to a pixel that corresponds in position to an interpolation target pixel of the n field shown by the moving/still image judgment information, and judges whether the n field including the interpolation target pixel constitutes a still image (Step S222).

If judging affirmatively (Step S222: Y), the I/P conversion unit 224 performs interpolation using a value of a pixel of an n−1 field that corresponds in position to the interpolation target pixel of the n field (Step S223).

Then, the I/P conversion unit 224 synthesizes the interpolated interpolation target pixel and a pixel before interpolation has been performed so as to generate a piece of video data in the progressive format, and outputs the converted piece of video data to the display unit 124 (Step S225).

Also, if judging negatively (Step S222: N), the I/P conversion unit 224 performs interpolation using pixels respectively arranged in lines above and below the interpolation target pixel of the n field (Step S224), and then performs processing of Step S225.

### Third Embodiment

### Outline

With the structure of the recording/playback system according to the second embodiment, by using a result of moving/still image judgment, the recording unit detects a specific pixel block including a macro block that has block noise, and records a piece of block noise information indicating the detected specific pixel block as an adjustment parameter. In order to play back a recorded video stream, the playback unit performs I/P conversion on pieces of video data included in the video stream for each frame, and turns on an LPF (Low Pass Filter) with respect to a piece of video data of the specific pixel block of the frame shown by the piece of block noise information to remove a high-frequency component, and also turns off the LPF with respect to a specific pixel block that has no block noise.

Here, Processing of detecting block noise according to the third embodiment is described.

For example, if the n−1 field and the n+1 field includes pixel data in the odd line and the n field that is a moving/still image judgment target includes pixel data in the even line, the moving/still image judgment unit 215 applies a result of moving/still image judgment made on the odd line to the even line in order to detect, a moving image constituted by the n field.

Also, the moving/still image judgment unit 215 performs Fast Fourier Transform (FFT) processing on luminance signals of video data of the n field in units of specific pixels in order to calculate a spatial frequency of the video data of the n field.

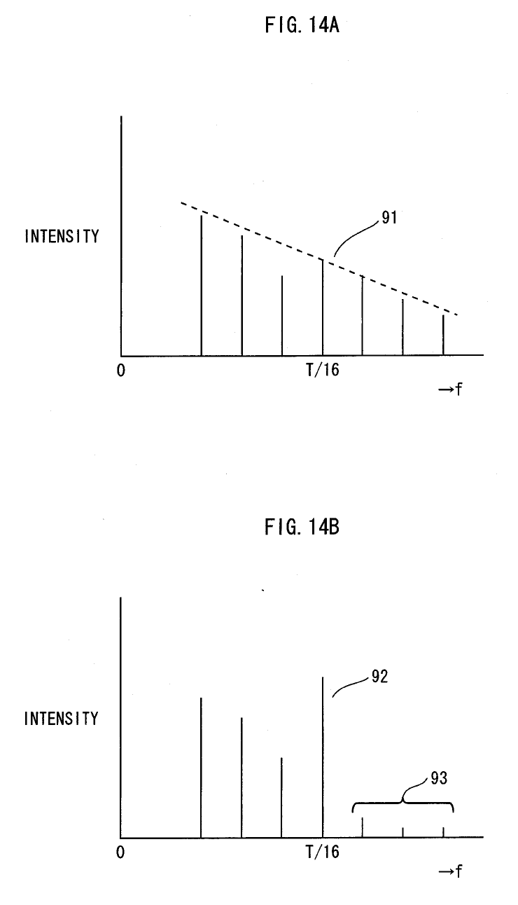

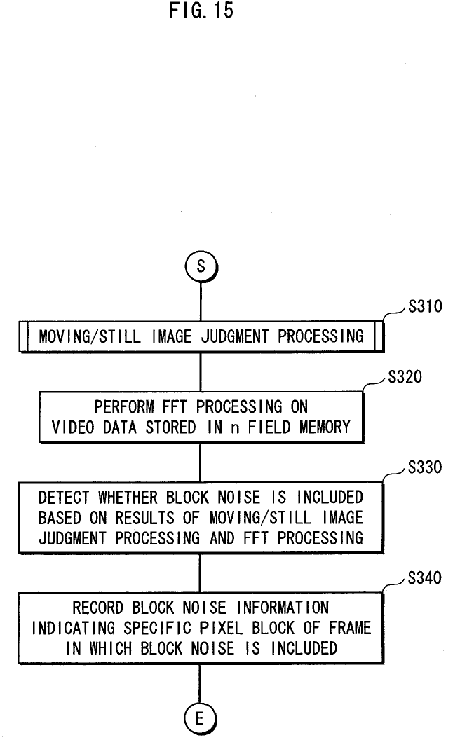

FIG. 14A shows a result of FFT processing in a case where no block noise is detected, and FIG. 14B shows a result of FFT processing in a case where a block noise is detected.

In a case where no block noise is detected, as a spatial frequency increases, an intensity of luminance signals decreases, as shown by a line 91 of FIG. 14A. In a case where a block noise is detected, an intensity of a spatial frequency T/16 corresponding to 16 pixels is higher as shown by a line 92 of FIG. 14B, and an intensity of a spatial frequency higher than T/16 extremely decreases as shown by lines 93 of FIG. 14B.

Therefore, in the third embodiment, in a case where a result of FFT processing performed on a moving image of each frame is like the result shown in FIG. 14B, it is judged that there is a block noise, and a block of a specific pixel is specified, and the specified block is recorded as a piece of block noise information.

### <Structure>

The following describes the structure of recording/playback system according to the third embodiment.

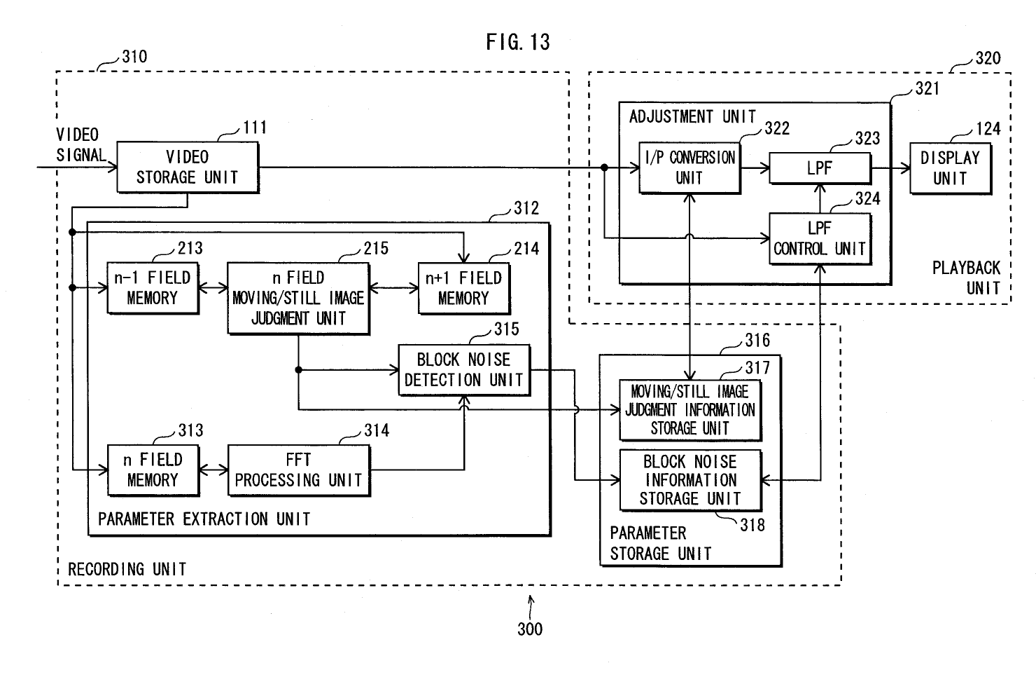

FIG. 13 shows the functional structure of a recording/playback system 300 according to the third embodiment.

The recording/playback system 300 includes a recording unit 310 and a playback unit 320. Compositional elements that are the same as those in the first and second embodiments are denoted with the same reference numbers, and accordingly the descriptions thereof are omitted.

The recording unit 310 includes a video storage unit 111, a parameter extraction unit 312, and a parameter storage unit 316.

The parameter extraction unit 312 includes, in the same way as in the second embodiment, an n−1 field memory 213 an n+1 field memory 214, and a moving/still image judgment unit 215, and further includes an n field memory 313, an FFT processing unit 314, and a block noise detection unit 315.

The n field memory 313 is a memory such as a RAM, and stores therein video data of an n field specified by the moving/still image judgment unit 215 as a moving/still image judgment target field.

The FFT-processing unit 314 performs FFT processing on luminance signals of video data stored in the n field memory 313 in units of specific pixel blocks such as 64 pixels×64 pixel blocks, and transmits an intensity of a spatial frequency as a result of the FFT processing to the block noise detection unit 315.

The block noise detection unit 315 judges whether the intensity of the spatial frequency T/16 shown by result of the FFT processing is no less than a predetermined value. If judging affirmatively, the block noise detection unit 315 judges whether a block on which the FFT processing has been performed is a moving image based on a result of moving/still image judgment transmitted by the moving/still image judgment unit 215, and detects whether block noise is included. Also, the block noise detection unit 315 transmits a piece of block noise information indicating the specific pixel block on which the FFT processing has been performed that includes block noise to the block noise information storage unit 318.

### <Operations>

The following describes operations of the recording/playback system 300 according to the third embodiment.

FIG. 15 shows a flow of adjustment parameter recording processing by the recording unit 310 of the recording/playback system 300.

The operations of the recording unit 310 are described with reference to FIG. 30.

In the same way as in the second embodiment, the moving/still image judgment unit 215 specifies an n field that is a moving/still image judgment target, and reads the n field and fields previous to and subsequent to the n field (an n−1 field and an n+1 field), and transmits the read fields of the video data to the field memories respectively corresponding to the fields. Also, the moving/still image judgment unit 215 performs processing of Steps S211 to S214 shown in FIG. 11, and transmits a result of the moving/still image judgment to the moving/still image judgment information storage unit 317 and the block noise detection unit 315 (Step S310).

The FFT processing unit 314 performs FFT processing on luminance signals of video data stored in the n field memory 313 in units of specific pixel blocks such as 64 pixels×64 pixel blocks, and transmits a result of the FFT processing to the block noise detection unit 315 (Step S320).

The block noise detection unit 315 detects whether block noise is included in the moving image of the n field, based on the result of the moving/still image judgment transmitted by the moving/still image judgment unit 215 in Step S310 and the result of the FFT processing transmitted by the FFT processing unit 314 in Step S320 (Step S330). The operation for detecting whether block noise is included is described later.

The block noise detection unit 315 transmits, to the block noise information storage unit 318, a specific pixel block of the field in which the block noise has been detected in Step S330 and a field number of the field in correspondence with each other (Step S340).

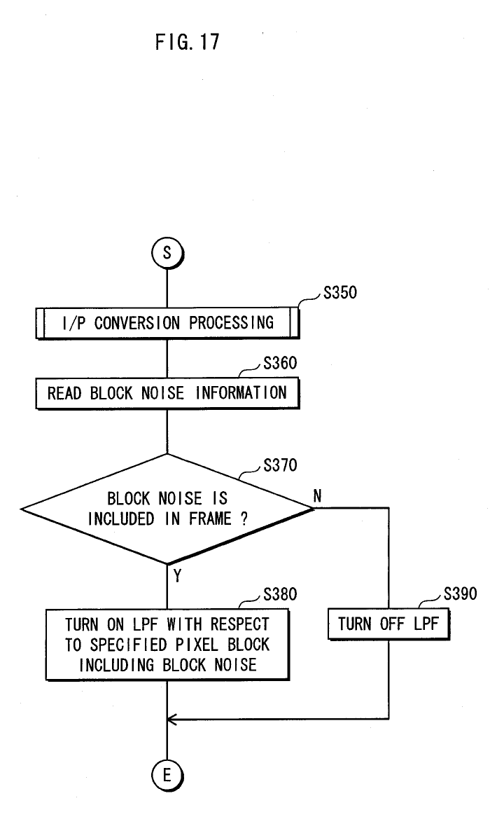

The following describes operations of playback processing by the playback unit 320 of the recording/playback system 300, with reference to FIG. 17.

In the same way as in the second embodiment, the I/P conversion unit 322 performs processing of Steps S220 to S224 shown in FIG. 12, and transmits video data of a frame generated by synthesizing the interpolated pixel and the original pixel to the LPF 323 (Step S350).

The LPF control unit 324 reads the piece of block noise information from the block noise information storage unit 318, and judges whether the frame of the video data input by the I/P conversion unit 322 is a frame having a field number shown by the piece of block noise information (Step S370).

If judging affirmatively (Step S370: Y), the LPF control unit 324 turns on the LPF 323 to remove high-frequency component with respect to video data of the specific pixel block shown by the piece of block noise information, and the display unit 124 displays the video data from which the high-frequency component has been removed by the LPF 323 (Step S380).

Also, if judging negatively (Step S370: N), the LPF control unit 324 turns off the LPF 323, and the display unit 124 displays the video data of the frame on which I/P conversion processing has been performed (Step S390).

Here, the operations of detecting whether block noise is included performed in Step S330 are described.

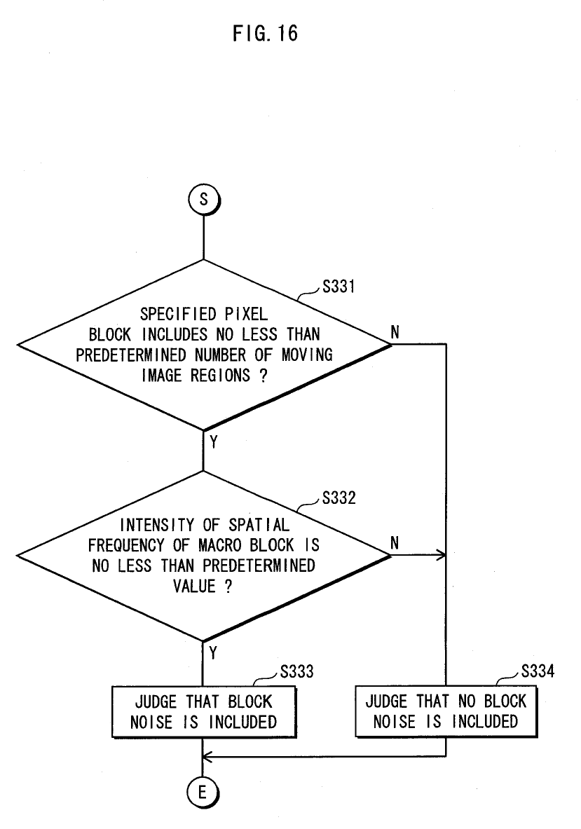

FIG. 16 shows a flow of block noise detection processing.

The block noise detection unit 315 judges whether a specific pixel block includes no less than a predetermined number of moving image regions based on a result of moving/still image judgment (Step S331).

If judging affirmatively (Step S331: Y), the block noise detection unit 315 further judges whether an intensity of a spatial frequency of a macro block is no less than a predetermined value, based on a result of the FFT processing on the specific pixel block (Step S332).

If judging affirmatively (Step S332: Y), the block noise detection unit 315 judges that the specific pixel block includes block noise (Step S333).

If judging negatively (Step S332: N), the block noise detection unit 315 judges that the specific pixel block does not include block noise (Step S334).

### <Conclusion>

The recording/playback system according to the present invention has been described based on the first to third embodiments.

According to the recording/playback system relating to the present invention, before a recorded video stream including pieces of video data is played back, with respect to each of the pieces of video data corresponding to a different time, it is possible to extract elements for performing video adjustment so as to determine adjustment parameters, from pieces of video data corresponding to a predetermined period including the time in the center thereof or pieces of video data corresponding to a predetermined period after the time. Then, it is possible to record the determined adjustment parameters and pieces of time information each indicating a time for displaying corresponding one of the pieces of video data.

As described above, it is possible to analyze pieces of video data included in a video stream before the video stream is played back, and determine adjustment parameters appropriate for different aims of image adjustment. Then, it is possible to record the determined adjustment parameters and pieces of time information each indicating a time for displaying a piece of video stream to which a different one of the adjustment parameters is to be applied. This makes it possible to improve the accuracy of image adjustment compared with the case of image adjustment is performed based on pieces of video data being played back.

Also, in a case of a service for sequentially transmitting pieces of video data of a video content such as a broadcast program accumulated in a server to a recording medium of a server for example, it is possible to determine adjustment parameters for the pieces of video data sequentially transmitted. Accordingly, users can watch the video content being played back with a preferable image quality.

### <Supplementary Description>

While the recording/playback system according to the present invention has been described based on the embodiments, it is possible to add the following modifications to the embodiments, and the present invention is of course not limited to the recording/playback system based on the embodiments.

(1) In the above first embodiment, although a PDP is used for displaying a video stream, a CRT (Cathode Ray Tube) display or an LCD may be employed instead.

For example, in a case where a CRT display is used, in order to suppress heat generation on a face plate glass of the display, luminance control is performed as shown by a broken line 31 of FIG. 3, in the same way as in the case of PDPs. According to the present invention, it is possible to detect a piece of video data whose APL transition matches the predetermined pattern (FIG. 5C). Accordingly, it is found that a dark scene continues for a predetermined period before a light scene starts and therefore heat is not generated for this predetermined period.

Therefore, in a case where it is found that APL transition of a piece of video data matches the predetermined pattern in the same way as in the first embodiment, control is performed so as to gradually decrease the APL at predetermined intervals as shown by the broken line 21 of FIG. 2. In this case, the LUT setup unit stores beforehand therein LUTs each including a control value of a different APL to be applied to the CRT, in the same way as in the first embodiment.

Also, in a case where an LCD is used, lighting is suppressed using a liquid-crystal shutter by stabilizing a luminance of a backlight. Accordingly, there is no correlation between heat generation and luminance, and luminance control based on APL is not performed. However, in a case of an LCD, after 0.2-0.4 seconds have elapsed since a video switched to a light scene, stimulation caused by luminance transition declines. Accordingly, even if subsequent display is performed with a luminance higher than the luminance used for displaying the light scene, impact to be received by users is the same as before, and this causes visual fatigue after all.

Accordingly, even in a case of an LCD, it is desirable to perform control so as to gradually decrease an APL at predetermined intervals, as shown by the broken line 21 of FIG. 2. Again, a control value for controlling a luminance in accordance with the LCD is stored beforehand in each LUT, in the same way as in the first embodiment. Regarding each of fields corresponding to times after elapse of 0.4 seconds since the APL increase for example, an LUT number is determined such that the luminance decreases at predetermined intervals.

(2) In the above first embodiment, LUTs respectively corresponding to PDPs are stored beforehand in the LUT setup unit 123. Alternatively, LUTs respectively corresponding to CRT displays and LCDs described in the above (1) may be also stored beforehand.

In this case, the recording unit acquires a type of a display. For example, a user inputs the type of the display into the recording unit, or the playback unit transmits the type of the display to the recording unit. Accordingly, it is possible to determine an LUT corresponding to the acquired type of the display, and perform preferable luminance adjustment appropriate to the type of, the display.

(3) Also, in the above first embodiment, in a case where a predetermined pattern is detected irrespective of age of a user that watches a video stream, luminance adjustment is performed so as to gradually decrease an APL at predetermined intervals for approximately 10 seconds. Alternatively, it may be possible to change a period for gradually decreasing an APL in accordance with age of a user that watches a video stream. For example, elderly users need a longer period for adaptation, a longer period for gradually decreasing an APL is determined.

In this case, in the same way as in the case of the display type as described in (2) above, LUTs determined for each user's age are stored beforehand in the LUT setup unit 123, and LUT numbers of the LUTs determined for each user's age are stored in the parameter storage unit 114 in one-to-one correspondence with field numbers each indicating a frame to which corresponding one of the LUTs is to be applied.

When a video stream is played back, a user inputs a piece of age information indicating a user's age to the playback unit, and the playback unit acquires the piece of age information. The playback unit selects an LUT corresponding to the acquired piece of age information from the parameter storage unit 114, and sets the selected LUT in the LUT 122.

(4) Also, in the above first embodiment, based on an LUT number determined and recorded by the recording unit, the playback unit, stores in the LUT 122 an LUT corresponding to the recorded LUT number so as to perform luminance adjustment. Alternatively, in a case where the recording unit detects a piece of video data whose APL transition matches the predetermined pattern (FIG. 5C), the recording unit may record a field number of an APL increased field and a parameter for gradually decreasing a luminance level, and the playback unit may select an LUT based on the recorded parameter and store the selected LUT in the LUT 122, or may calculate a luminance based on the recorded parameter.
(5) Also, in the above first embodiment, in a case where APL transition of original video data matches the predetermined pattern (FIG. 5C), luminance adjustment is performed so as to gradually decrease a luminance level from the APL increased field at predetermined intervals. Alternatively, as long as a luminance level is decreased after the luminance level has increased to the APLmax, luminance adjustment is not limited to the above method.
(6) In the above second embodiment, the n field moving/still image judgment unit 215 transmits a result of moving/still image judgment for each interpolation target pixel as an adjustment parameter to the parameter storage unit 216. The parameter storage unit 216 stores therein the result of the moving/still image judgment. Alternatively, the n field moving/still image judgment unit 215 may transmit, to the parameter storage unit 216, only a result of moving/still image judgment of an interpolation target pixel that shows the pixel is a moving image. This realizes effective use of regions of the parameter storage unit 216.

Also, in the above second embodiment, the n field moving/still image judgment unit 215 makes moving/still image judgment on all interpolation target pixels in fields. Alternatively, it may be employed to make moving/still image judgment on only a specified interpolation target pixel among all interpolation target pixels, and apply a result of the moving/still image judgment made on the specified interpolation target pixel to other interpolation target pixels. This decreases the circuit size for making moving/still image judgment.

(7) Also, in the above second embodiment, moving/still image judgment is made using values of pixels of fields (an n−1 field and an n+1 field) immediately previous to and immediately subsequent to an n field that is a target of the judgment.

Furthermore, it may be employed to make moving/still image judgment using values of pixels of fields (an n−2 field and an n+2 field) including a field that is two fields previous to an n field that is a target of the judgment and a field that is two fields subsequent to the n field, in addition to of the values of the pixels of the n−1 field and the n+1 field.

For example, in a case where a result of moving/still image judgment shows a moving image is prioritized, moving/still image judgment is made using original pixels of an n−2 and an n+2 field respectively arranged in lines above and below an interpolation target pixel, and furthermore, moving/still image judgment is made using original pixels of an n−1 and an n+1 field in the same way as in the second embodiment. If both results of the moving/still image judgments show still images, it is judged that a field including the interpolation target pixel constitutes a still image.

(8) In the above embodiments, adjustment parameters are not recorded in the video storage unit 111 in which pieces of video data is stored, but are stored in the parameter storage unit 216. Alternatively, it may be employed to store adjustment parameters together with the pieces of video data in one-to-one correspondence, using digital watermark.

For example, in a case where adjustment parameters and pieces of time information relating to MPEG video data are embedded in a motion vector, with respect to each of the adjustment parameters and the pieces of time information, one bit in each bit string is extracted. Depending on whether a value of the extracted bit is 0 or 1, a pixel that is most adjacent to an original pixel is obtained from among pixels surrounding a reference pixel indicated by a motion vector in units of pixels based on a motion vector search range. Then, a vector indicating the obtained pixel is determined to be a new motion vector, and all the adjustment parameters and the pieces of time information are embedded in the video data, and the video data is again compressed and recorded.

As described above, by embedding an adjustment parameter into a video content, it is possible to read the adjustment parameter together with reading video data. This realizes image adjustment such as luminance adjustment based on the read adjustment parameter.

### INDUSTRIAL APPLICABILITY

The recording/playback system according to the present invention can be utilized for hard disk recorders and DVD (Digital Versatile Disc) recorders for recording and playing back video contents, and network video devices or the like in accordance with the DLNA (Digital Living Network Alliance).

1. A recording/playback system that includes a recording device that records therein pieces of video data and a playback device that plays back the recorded pieces of video data,
the recording device comprising
a recording unit operable to sequentially determine video adjustment parameters for the pieces of video data each having a predetermined period, and record the determined video adjustment parameters and pieces of time information in a recording medium, the pieces of time information indicating display timings of the pieces of video data, and
the playback device comprising
a playback unit operable to adjust the pieces of video data based on the video adjustment parameters, and display the adjusted pieces of video data in accordance with the display timings indicated by the pieces of time information.

2. The recording/playback system of claim 1, wherein
the video adjustment parameters are parameters for adjusting luminances of the pieces of video data, and
the recording unit (i) calculates average luminances of the pieces of video data, (ii) judges whether transition of the calculated average luminances matches a predetermined luminance increase pattern, (iii) when judging affirmatively, determines video adjustment parameters for gradually decreasing luminance levels of particular pieces among the pieces of video data, the particular pieces being subsequent to one piece among the pieces of video data whose average luminance is a maximum among the average luminances, and (iv) records the video adjustment parameters determined for the particular pieces and display timings of the particular pieces in the recording medium.

3. The recording/playback system of claim 2, wherein
the recording unit acquires one or more playback conditions for playing back the pieces of video data, and determines the video adjustment parameters in accordance with the acquired one or more playback conditions based on the average luminances of the pieces of video data, and records the determined video adjustment parameters and the pieces of time information in the recording medium in one-to-one correspondence.

4. The recording/playback system of claim 3, wherein
each of the playback conditions indicates a different one of types of playback devices for playing back the pieces of video data, and
the recording device determines the video adjustment parameters in accordance with the types, and records the determined video adjustment parameters and the pieces of time information respectively corresponding thereto in the recording medium in one-to-one correspondence with the types.

5. The recording/playback system of claim 1, wherein
video signals relating to the pieces of video data are signals transmitted in an interlaced mode,
the recording device further comprises
a judgment unit operable to judge, with respect to each of fields relating to the video signals that is a target field of judgment, whether the target field constitutes a moving image or a still image based on pixels included in at least two fields that correspond in position to a pixel included in the target field, the at least two fields including a field previous to the target field and a field subsequent to the target field,
the recording unit records, as a video adjustment parameter for the field, a result of the judgment made by the judgment unit and a piece of field time information indicating a time that corresponds to the target field in the recording medium in correspondence with each other, and
the playback unit converts the video signals into progressive signals by switching between reference fields for interpolating the pixel depending on the result of the judgment included in the video adjustment.

6. The recording/playback system of claim 1, wherein
the recording unit embeds, as digital watermark, the video adjustment parameter and the piece of time information into the piece of video data, and records, in the recording medium, the piece of video data into which the video adjustment parameter and the piece of time information have been embedded.

7. A recording device that records therein pieces of video data, the recording device comprising
a recording unit operable to sequentially determine video adjustment parameters for the pieces of video data each having a predetermined period, and record the determined video adjustment parameters and pieces of time information in a recording medium, the pieces of time information indicating display timings of the pieces of video data.

8. A playback device that reads pieces of video data each having a predetermined period from a recording medium having recorded therein the pieces of video data, video adjustment parameters for the pieces of video data, and pieces of time information indicating display timings of the pieces of video data, and plays back the read pieces of video data, the playback device comprising
a playback unit operable to adjust the pieces of video data based on the video adjustment parameters, and display the adjusted pieces of video data in accordance with the display timings indicated by the pieces of time information.

9. A recording medium having recorded therein pieces of video data, video adjustment parameters for the pieces of video data, and pieces of time information indicating display timings of the pieces of video data.
